(19) United States
(12) Patent Application Publication
(10) Pub. No.: US 2024/0078506 A1
(43) Pub. Date: Mar. 7, 2024

(54) SAFETY STOCK CORRECTION APPARATUS, METHOD, AND MEDIUM

(71) Applicant: Grote Industries, LLC, Madison, IN (US)

(72) Inventors: Neil CLAYTON, Madison, IN (US); Joseph LISLE, Madison, IN (US); Eloy MENDOZA, Cipreses San Nicolas de los Garza (MX)

(21) Appl. No.: 17/903,397

(22) Filed: Sep. 6, 2022

(51) Int. Cl. G06Q 10/08; G06Q 10/06

(52) U.S. Cl. CPC G06Q 10/087; G06Q 10/06311

(57) ABSTRACT

A safety stock correction represents a number of units over standard inventory that will meet intense increases in demand. In the safety stock correction, an average present demand, a total present demand, a total past demand for each past day, and a standard deviation of total demand are obtained. Further, an average present lead time, an average past lead time for each past day, and a standard deviation of average lead time are obtained. A standard deviation of lead time demand is obtained, which is the square root of a sum of a product of the average present lead time and the square of the standard deviation of total demand and a product of the average present demand and the square of the standard deviation of average lead time. The safety stock correction is a product of a service level and the standard deviation of lead time demand.

### BACKGROUND

Enterprises of all sizes are faced with a supply issue that occurs when demand for a an item rapidly and intensely increases. Specifically, an enterprise maintains an inventory of an item based on a normal and customary demand. However, occasionally demand for quantities of the item rises far beyond that which is normal.

Safety stock is an amount of the item that an enterprise maintains in order to satisfy occasional extra intense demand for an item. However, determining an appropriate safety stock amount is a challenging and difficult proposition.

Often, an enterprise has multiple consumers of an item, each consumer having its own particular demand for a quantity of the item. Further, each consumer not only demands a quantity of the item, but also has a time frame in which the consumer is expecting to receive the quantity of the item demanded after an order for the item is placed.

The time frame in which the consumer expects to receive the ordered quantity of the item is known as lead time. Lead time can be informally agreed to between consumers and an enterprise. However, lead time is often a contractual arrangement between consumers and a supplier of an item. Failure by a supplier to meet a lead time may result in penalties.

A related concept to lead time is service level. Service level is an internal value of an enterprise that is a percentage value of how often the enterprise expects to have delivery of an item fall within the agreed-to or contractual lead time. It should be noted that service level may change among multiple different items provided by a single entity.

A conventional determination of safety stock assumes that multiple different consumers of varying types (such as resellers, manufacturers, retailers, etc.), and having widely varying demands for quantities of an item, maintain the same constant lead time. Such a determination, unfortunately, is not an accurate modeling of real-world transactions.

Conventional approaches to safety stock calculation and inventory control further also face difficulty when there is significant uncertainty and/or instability in demand regularity. That is to say, conventional approaches to safety stock calculation and inventory control operate on a principle that there is some predictability in demand.

Such predictably might result in a demand curve that is bell shaped. Conventional approaches to safety stock calculations, however, are unable to adjust for demand that is extremely unpredictable, such as in the year 2020 when the worldwide pandemic created upheaval in economic systems.

### SUMMARY

The present disclosure reveals a determination of safety stock (that is, a safety stock correction) that accounts for demand under normal economic circumstances, all well as when demand is extremely irregular, and further considers multiple variable lead times from multiple consumers, each consumer having a particular demand.

Accordingly, one embodiment disclosed herein describes a safety stock correction server. The safety stock correction server comprises an electronic data storage, a transceiver, a processor, and a bus. The transceiver is configured to transmit and receive data over a network. The bus is configured to transfer data among the electronic data storage, the transceiver, and the processor, rendering the processor cooperatively operable with the electronic data storage and the transceiver.

The electronic data storage stores a begin day, a present day, and at least one past day. The present day is subsequent to the begin day. The at least one past day is any day between the begin day and the present day.

The electronic data storage further stores, for each of a plurality of different entities, a present demand. The present demand is a number of units of an item requested on the present day by an entity.

The electronic data storage further stores, for each of the plurality of different entities, a present lead time. The present lead time is a number of days between the present day and a present delivery day. The present delivery day is a day for delivery to an entity of its present demand.

The electronic data storage further stores, for each of the plurality of entities, and for each past day, a past demand. The past demand is a number of units of the item requested by an entity on a respective past day.

The electronic data storage further stores, for each of the plurality of entities, and for each past day, a past lead time. The past lead time is a number of days between a past day and a past delivery day. The past delivery day is a day for delivery to an entity of a past demand.

The electronic data storage further stores a service level. The service level is a percentage value representing how often units of the item are expected to be delivered within a given lead time.

The processor performs a safety stock correction calculation for the present day. In the safety stock correction for the present day, the processor obtains an average present demand. The average present demand is an average of the present demand of the plurality of entities.

In the safety stock correction for the present day, the processer further obtains a total present demand. The total present demand is a sum of the present demand of each of the plurality of entities.

In the safety stock correction for the present day, the processor further obtains for each past day a total past demand. The total past demand is a sum of the past demand of each of the plurality of entities for a respective past day.

In the safety stock correction for the present day, the processor further obtains a standard deviation of total demand. The standard deviation of total demand is based on the total present demand and the total past demand of each past day.

In the safety stock correction for the present day, the processor further obtains an average present lead time. The average present lead time is an average of the lead time of the present demand of the plurality of entities.

In the safety stock correction for the present day, the processor further obtains for each past day, an average past lead time. The average past lead time is an average of the past lead time of the past demand of the plurality of entities for a respective past day. In the safety stock correction for the present day, the processor further obtains a standard deviation of average lead time based on the average present lead time and the average past lead time of each past day.

In the safety stock correction for the present day, the processor further obtains a standard deviation of lead time demand. The standard deviation of lead time demand is the square root of a sum of a first addend and a second addend. The first addend is a product of the average present lead time and the square of the standard deviation of total demand. The second addend is a product of the average present demand and the square of the standard deviation of average lead time.

In the safety stock correction for the present day, the processor further obtains a safety stock correction. The safety stock correction is a product of the service level and standard deviation of lead time demand. The safety stock correction additionally represents a number of units of the item over standard inventory for meeting intense increases in demand.

A safety stock correction method is also described herein, the safety stock correction method reciting functionality and/or features that are similar to the functionality and/or features of the safety stock correction server described above. As well, a non-transitory computer-readable storage medium is disclosed herein, reciting functionality and/or features that are similar to the functionality and/or features of the safety stock correction server described above.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating a first embodiment of a novel safety stock correction system.

FIG. 2 is a block diagram illustrating a second embodiment of a novel safety stock correction system.

FIG. 3 is an exemplary spreadsheet demonstrating the functionality of a novel safety stock correction apparatus or system.

FIG. 4 is block diagram illustrating a novel safety stock correction apparatus.

FIG. 5 is a block diagram illustrating a safety stock correction method.

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented in a processor, are best supported with or in software or integrated circuits (ICs), such as a digital signal processor, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

In the present discussion, certain terms and phrases are described so as to enhance understanding of inventive principles. However, any conflict in meaning between a definition of a term or expression in the claims and a definition or description of the same term or expression in this discussion and/or in the drawings will be governed by the definition in the claims.

As noted above, safety stock correction is based on a several factors, and is determined as of a given present day. That is to say, an enterprise or other entity seeks to determine how much quantity of an item needs to be available on a given present day as safety stock in order to satisfy any potential intense demand for the item in the near future.

The factors used in determining safety stock correction for a given present day are given by safety stock equations as follows:

$${σ}_{LTD} = \sqrt{\overline{LT} * {σ}_{D}^{2} + \overline{D} * {σ}_{LT}^{2}} \qquad ( Equation 1 )$$

$$SS = Z * {σ}_{LTD} \qquad ( Equation 2 )$$

The expressions in the above equations are now described. The symbol D in the equation above simply indicates total daily demand for a number of units of an item by one or more entities. That is to say, on a given day, there is a total demand for a number of units of an item to be supplied.

There is also an average present daily demand D̅ of the units by the one or more entities. It should be noted, however, that there can also be a past demand. At this point, however, focus is on present demand.

In Equation 1 above, the expression D̅ simply indicates an average present daily demand of a plurality of entities. That is to say, each entity has a present daily demand of a number of units of an item on a present day. D̅ (average present demand) is simply the average of these present daily demands.

As indicated above, another factor in determining safety stock correction is lead time, symbolically represented as LT. Similar to demand D, lead time LT can either be a present lead time or a past lead time. At this point, focus is on present lead time.

Present lead time is simply a number of days (or other time units) that are between a present day and a present delivery day. The present delivery day is a day for delivery to an entity of its present demand,

In Equation 1 above, the expression L̅T̅ simply indicates an average present lead time of the present demand of the one or more entities. That is to say, each entity has a present lead time for its present demand. L̅T̅ (average present lead time) is simply the average of these present lead times.

The expressions σ_{D} and ρ_{LT} respectively symbolically represent the standard deviation of total demand and the standard deviation of average lead time. The standard deviation of total demand σ_{D} considers both present total demand and past total demand. Present total demand is of course simply the sum of the present of demand of the one or more entities on the present day.

Past total demand is slightly more complex. There is a past total demand for each past day. The past demand of each entity on a respective past day are summed to obtain the total past demand for the respective past day. The standard deviation of total demand σ_{D} is then the standard deviation taken over the total present demand of the present day and the total past demand of every past day on which a quantity of the item was demanded.

The standard deviation of average lead time σ_{LT} considers both present average lead time and past average lead time. Present average lead time is simply the average of present lead time of the present demand of the one or more entities on the present day.

Past average lead time is slightly more complex. There is an average past lead time for each past day. The average past lead time is the average of the past lead time of the past demand of each of the one or more entities on a respective past day. The standard deviation of average lead time a σ_{LT} is thus taken over the present average lead time and the past average lead time of every past day on which a quantity of the item was demanded.

Once the standard deviation of lead time demand σ_{LTD} is obtained, the actual safety stock correction can be obtained using Equation 2. Specifically, safety stock is the product of the standard deviation of lead time demand σ_{LTD} and the service level Z. Generally, a service is 95% or 0.95. However, the service level may vary depending on the nature of the item being supplied. For example, the more variable the time required to assemble an item to be supplied and delivered, the lower the service level.

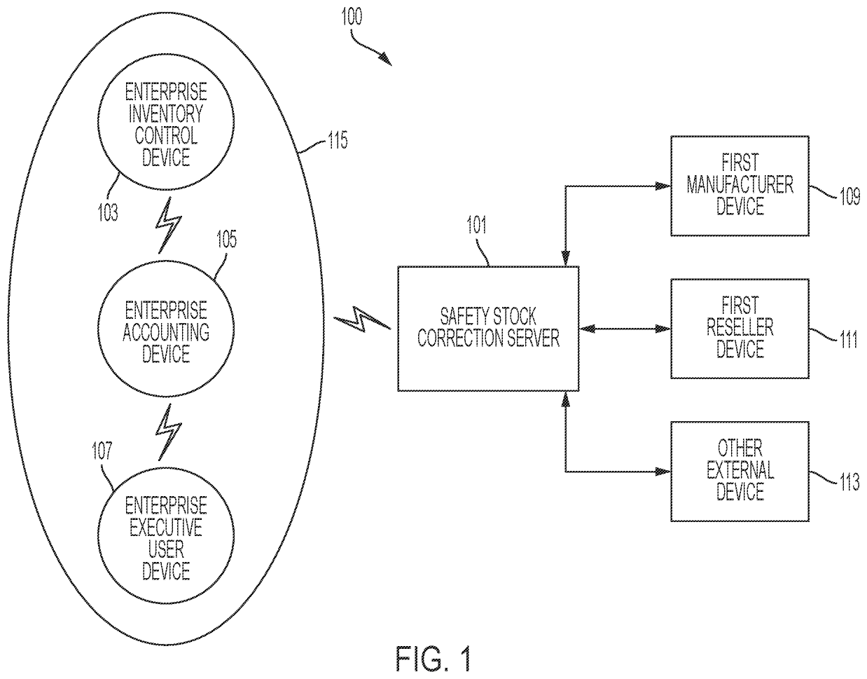

Now that an overview of the safety stock correction has been provided, a safety stock correction system is discussed and described. FIG. 1 is a block diagram illustrating a safety stock correction system 100 that performs a safety stock correction according to Equation 1 and Equation 2 above.

The safety stock correction system 100 includes a safety stock correction server 101, an enterprise network 115, a first manufacture device 109, a first reseller device 111, and another external device 113. The safety stock correction server 101 is server device that implements the safety stock correction functionality noted above with respect to Equation 1 and Equation 2, and described in greater detail further below.

The safety stock correction server 101 in this embodiment is a device operated by an independent third party that manages inventory of the enterprise 115. That is to say, the safety stock correction server 101 is an intermediate network device that aids the enterprise 115 in managing inventory in response to demand of items by the first manufacture device 109, the first reseller device 111, and the other external device 113.

It should be clear that the safety stock correction server 101 in an ongoing fashion determines how much safety stock must be acquired on a daily basis in order to meet possible rapidly increased demand. The safety stock correction determination thus effects inventory control and accounting control of the enterprise 115.

The enterprise inventory control device 103 and the enterprise accounting device 105 are thus connected over one or more networks to the safety stock correction server 101 in order to rapidly and efficiently undertake logistical steps responsive to a safety stock correction. For example, if the safety stock correction server 101 determines on a particular day a safety stock correction value that is greater than a current safety stock level, this determination is communicated to the inventory control device 103. The inventory control device 103 can then take the necessary actions in order to obtain the corrected increased safety stock. For example, the inventory control device 103 may be in further communication with a production line, production facility, warehouse, parts ordering department, and others known in the art.

It should also be clear that inventory control actions such as procurement of parts and/or production increases will also effect accounting of the enterprise. Thus, the enterprise accounting device 105 communicates with both the safety stock correction server 101 and the enterprise inventory control device 103 to receive data that effects accounting control.

For example, if it is determined by the enterprise inventory control device 103 that in order to obtain a safety stock correction amount of an item (as determined by the safety stock correction server 101), a certain number of other constituent parts must be ordered. In such a case, the enterprise accounting device 105 can undertake the necessary accounting processes to maintain the balance sheet of the enterprise as the parts are procured.

The enterprise inventory control device 103 and enterprise accounting device 105 are exemplary devices of the enterprise network 115. These devices should not be viewed as limiting, and other devices of the enterprise network 115, within the knowledge of one or ordinary skill in the art, will also be able to communicate with the safety stock correction server 101.

One such other device of the enterprise network 115 is the enterprise executive user device 107. This device is simply a client device of an executive of the enterprise that on occasion will need access to all aspects of the operation of the enterprise network 115, including the safety stock correction server 101. Thus, the enterprise executive user device 107 may not necessarily communicate with the safety stock correction server 101 every time the safety stock correction server 101 makes a safety stock correction. However, the enterprise executive user device 107 will access the safety stock correction server 101 on an as-needed basis.

The enterprise that is the source of the enterprise network 115 of course has commercial interactions with a number of different entities. Examples of these different entities are seen in FIG. 1, and include a first manufacturer 109, a first reseller 111, and others 113. The first manufacturer 109 is simply another entity, different from the enterprise, that uses an item produced and supplied by the enterprise in the manufacture of a further item.

That is to say, the first manufacturer 109 places orders for items supplied by the enterprise network 115 through the safety stock correction server 101, or through another network that accesses the safety stock correction server 101. The first manufacturer 109 then uses the supplied items in a further manufacture of an additional product

The first reseller 111 also places orders of items produced by the enterprise affiliated with the enterprise network 115, through the safety stock correction server 101 or through another network connected to the safety stock correction server 101. However, the first reseller 111 may simply further resell the obtained items. That is to say, the relationship of the producing enterprise and the first reseller 111 may be that of manufacturer and retailer, or wholesaler and retailer. The first reseller 111 may also be an entity that sells goods to the public.

There may be any number of other external entities, such as the external device 113, known to a person of ordinary skill in the art that demand items from the enterprise network 115. Each of the other entities will place orders though the safety stock correction server 101.

It should be noted that when one or more of the first manufacturer 109, the first reseller 111, and the other external entities 113 place orders through the safety stock correction server 101, the order will specify the quantity of the item demanded along with a lead time in which the quantity of the item is expected to be delivered. In some cases, the lead time will have been previously agreed to, and the order may reference the previous agreement. In other cases, the order will specify a new lead time based on any number of factors.

Entry of orders to the safety stock correction server 101 can be made in multiple different ways. For example, orders can be entered manually by a human operator of the safety stock correction server 101, through a peripheral, based on data received from the first manufacturer 109, the first reseller 111, and any of the other external entities 113. The human operator may receive the data/order by phone, by email, by text message, by known social media techniques, and by another communication medium known in the art.

Additionally, orders may be received at the safety stock correction server 101 in an automated process where the first manufacturer 109, the first reseller 111, and any of the other external entities 113 are able to communicate without human intervention in the communication process. Further, artificial intelligence learning techniques may be used by the safety stock correction server 101 to predict orders that can by processed by the safety stock correction server either with or without confirmation of the order by one of the first manufacturer 109, the first reseller 111, and any of the other external entities 113.

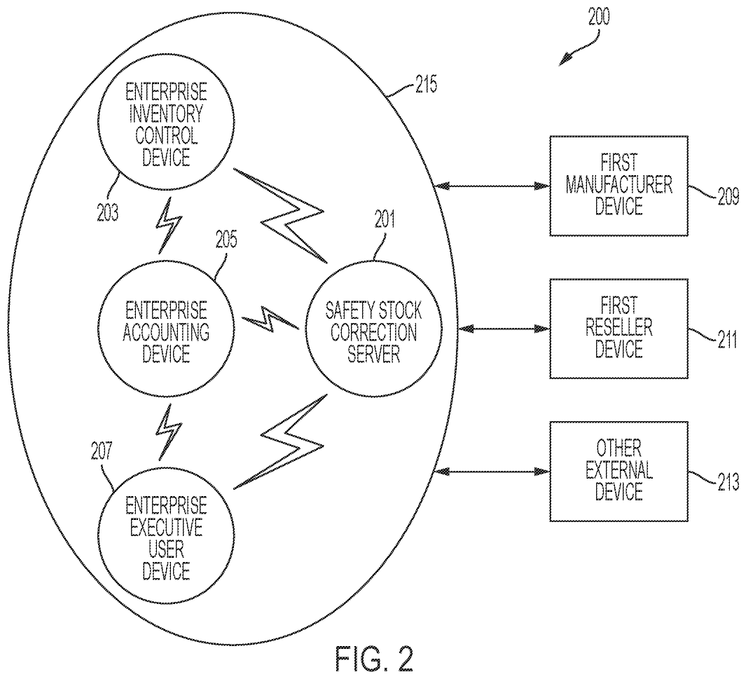

Turning to FIG. 2, a block diagram illustrating a novel safety stock correction system 200 is now described. In FIG. 2, the safety stock correction server 201 is integrated into the enterprise network 215. In this second embodiment, the safety stock correction server 201 is managed and maintained directly by the enterprise.

In FIG. 2 the enterprise inventory control device 203, the enterprise accounting device 205, and the enterprise executive user device 207 are connected to the safety stock correction server 201 over an intranet or other enterprise network rather than a public or third party network. Additionally, the safety stock server 201 is directly accessible by the devices 203, 205, 207.

In the second embodiment of FIG. 2, each of the first manufacture device 209, the first reseller device 211, and the other external device 213 do not directly access to the safety stock correction server 201. Rather orders are placed through either the enterprise inventory control device 203, through an electronic ordering system, or through a human interaction of some type.

In the embodiment of FIG. 2, the type of orders placed by the first manufacture device 209, the first reseller device 211, and the other external device 213 are similar to orders in the first embodiment. That is, orders will specify the quantity of the item demanded along with a lead time in which the quantity of the item is expected to be delivered.

A more technical description of the devices in FIGS. 1 and 2 is now provided. Description is made of the devices in FIG. 1, but the descriptions are equally applicable to the devices of FIG. 2. The following technical description should be viewed as an alternative arrangement if any description conflicts with the discussion above.

Each of the safety stock correction server 101, the first manufacturer device 109, the first reseller device 111, the other external device 113, the enterprise inventory control device 103, the enterprise accounting device 105, the enterprise executive user device 107, and the enterprise network 115 (hereinafter collectively referred to as “computer systems/networks 101, 109, 111, 113, 103, 105, 107, 115”) may be viewed as a computer system or network. The computer systems/networks 101, 109, 111, 113, 103, 105, 107, 115 may communicate each with the other over any network such as the Internet, an intranet, or any other network. Each computer system/network 101, 109, 111, 113, 103, 105, 107, 115 may be programmed to operate in automated fashion, and may also have an analog or a graphic user interface such as Outlook and Windows such that users can control computer systems/network 101, 109, 111, 113, 103, 105, 107, 115.

Each computer system/network 101, 109, 111, 113, 103, 105, 107, 115 may include at least a central processing unit (CPU) with data storage such as disk drives, the number and type of which are variable. In each computer system/network 101, 109, 111, 113, 103, 105, 107, 115 there might be one or more of the following: a floppy disk drive, a hard disk drive, a solid state drive, a CD ROM or digital video disk, or other form of digital recording device.

Each computer system/network 101, 109, 111, 113, 103, 105, 107, 115 may include one or more displays upon which information may be displayed. Input peripherals, such as a keyboard and/or a pointing device, such as a mouse, may be provided in each computer system/network 101, 109, 111, 113, 103, 105, 107, 115 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system/network 101, 109, 111, 113, 103, 105, 107, 115 may interconnect peripherals previously mentioned herein through a bus supported by a bus structure and protocol. The bus may serve as the main source of communication between components of each computer system/network 101, 109, 111, 113, 103, 105, 107, 115. The bus in each computer system/network 101, 109, 111, 113, 103, 105, 107, 115 may be connected via an interface.

The CPU of each computer system/network 101, 109, 111, 113, 103, 105, 107, 115 may perform the calculations and logic operations required to execute the functionality of each computer system as described in this disclosure. The functionality of each computer system/network 101, 109, 111, 113, 103, 105, 107, 115 may be processed in an automated fashion such that relevant data is processed without user administrator assistance or intervention. Alternatively, or additionally, the functionality of each computer system/network 101, 109, 111, 113, 103, 105, 107, 115 may be processed in a semi-automatic fashion with intervention from a user administrator at one or more of the computer systems/networks 101, 109, 111, 113, 103, 105, 107, 115. Alternatively, or additionally, the functionality of computer system/network 101, 109, 111, 113, 103, 105, 107, 115 may be improved based on learning, problem-solving, or rational choice-making obtained through current or future artificial intelligence techniques. Implementing, processing, and executing the functionality of each computer system/network 101, 109, 111, 113, 103, 105, 107, 115 as described in this disclosure is within the purview and scope of one of ordinary skill in the art, and is not discussed in detail herein.

Each computer system/network 101, 109, 111, 113, 103, 105, 107, 115 may be implemented as a distributed computer system or a single computer. Similarly, each computer system/network 101, 109, 111, 113, 103, 105, 107, 115 may be a general purpose computer, or a specially programmed special purpose computer. Moreover, processing in each computer system/network 101, 109, 111, 113, 103, 105, 107, 115 may be controlled by a software program on one or more computer systems or processors, or could even be partially or wholly implemented in hardware. The computer systems/networks 101, 109, 111, 113, 103, 105, 107, 115 used in connection with the functionality may rely on the integration of various components including, as appropriate and/or if desired, hardware and software servers, database engines, and/or other content providers.

Although the computer systems/networks 101, 109, 111, 113, 103, 105, 107, 115 in FIG. 1 are illustrated as being a single device or computer, each computer system according to one or more embodiments of the invention is optionally suitably equipped with a multitude or combination of processors or storage devices. For example, each computer illustrated in computer systems and network 101, 109, 111, 113, 103, 105, 107, 115 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system/network 101, 109, 111, 113, 103, 105, 107, 115 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems/networks 101, 109, 111, 113, 103, 105, 107, 115. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more of the computer systems/networks 101, 109, 111, 113, 103, 105, 107, 115 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system/network 101, 109, 111, 113, 103, 105, 107, 115 may be connected over the Internet, an intranet, or over a further network. Links to any network may be a dedicated link, a modem over a POTS line, and/or any other method of communicating between computers and/or users.

Each computer system/network 101, 109, 111, 113, 103, 105, 107, 115 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked.

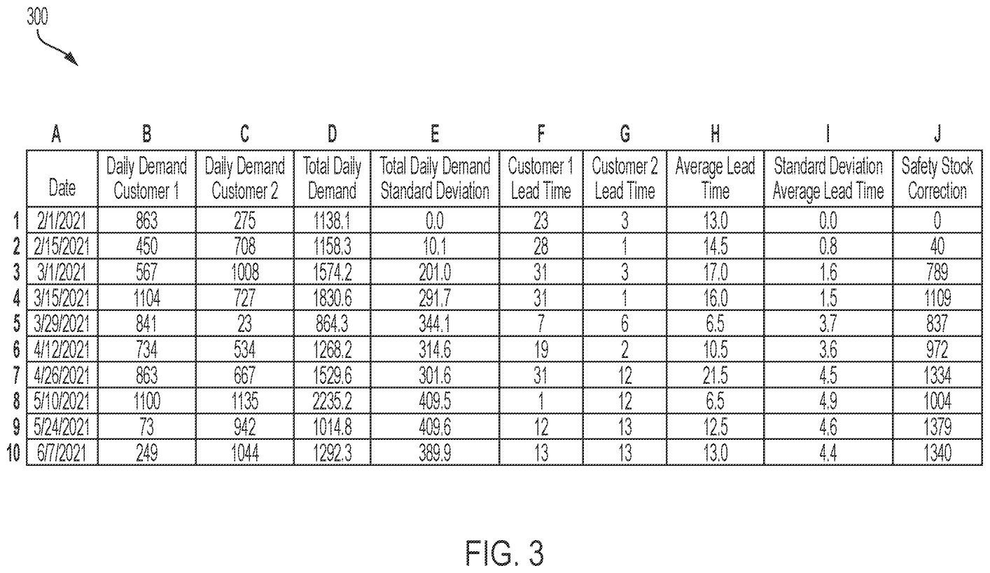

Turning now to FIG. 3, an exemplary spreadsheet 300 demonstrating the functionality of the disclosed safety stock correction apparatus is discussed and described. FIG. 3 illustrates certain data that is stored in the memory of a safety stock correction apparatus (discussed further below) as well as data that is obtained as a result of processing of the safety stock apparatus.

The spreadsheet 300 is characterized by ten rows (denoted by numbers 1-10) and ten columns (denoted by letters A-G). Each row represents a particular day (present day) on which data is obtained and calculated. That is, each row represent a day on which an order is placed.

The spreadsheet 300 indicates that a first (beginning) day occurs on Feb. 1, 2021 when a daily demand customer 1 and a daily demand customer 2 place orders for (that is,—demand) 863 and 275 units, respectively. The next subsequent day where orders are placed is two weeks later on Feb. 15, 2021 where daily demand customer 1 and a daily demand customer 2 place orders for (that is demand) 450 and 708 units, respectively.

In FIG. 3, orders are placed by daily demand customer 1 and daily demand customer 2 at intervals of approximately every two weeks. However, this interval is completely exemplary, and intervals between orders can be of any period of time any interval, including for example a 12-hour period, a 24-hour period, a 48-hour period, a 120-hour period, a week period, a month period, and the like. It could also be that there is no regular interval at all between orders, and that order days vary in length from previous order days.

It should be noted that the spreadsheet 300 is a snapshot after data has been entered at the tenth day, on 06/07/2. That is, the spreadsheet 300 continues to grow by row as additional orders are placed on each given day.

Any particular day on rows 1-10 can be considered a present day when the data is entered or obtained. When considering any day on rows 1-9, the days above any day on rows 1-9 would not have any rows below the present row as those days have not occurred yet. Starting with the day on row 2, past days are the days above the present day under consideration, the days above any present day having come before the present day.

The columns of the spreadsheet 300 are now described. Column A represents the date orders for a quantity of an item are placed. Columns B and C shows the number of units demanded (ordered) by a 1^{st} Customer and a 2^{nd} Customer, respectively. Column D represents the total present daily demand for a quantity of the item on a present day.

The present average daily demand (see Equation 1, D̅) is not presented in a column of its own, but is the average of Column B and Column C on any present day. Column E represents the standard deviation of total demand (see Equation 1, σ_{D}) on a given present day.

Column F represents a present lead time for the demand under Column B of the 1^{st} Customer on a given present day. Column G represents the lead time for the demand under Column C of the 2^{nd} Customer on a present day. Column H represents the average of present lead times (see Equation 1, L̅T̅) on a present day of the 1^{st} Customer under Column F and the 2^{nd} Customer under Column G. Column I represents the standard deviation of average lead time (see Equation 1, σ_{LT}) on a given present day. Lastly, Column J represents the safety stock correction on a given present day as obtained by Equation 1 and Equation 2, when the service level Z is set to 0.95.

A brief example of the calculations of Equation 1 and Equation 2 is now provided. The data on Row 3 (on the date of Mar. 1, 2021) is now considered. It can be seen from Column B that the demand for the 1^{st} Customer on Mar. 1, 2021 is 567. It can be seen from Column C that the demand for the 2^{nd} Customer on Mar. 1, 2021 is 1008.

The present average present demand D̅ is therefore (567+1008)/2=787.5. Therefore, in Equation 1, the average present demand D̅ is set to 788 units.

Column D at Row 3 represents the total demand for Mar. 1, 2021. The total daily demand for Mar. 1, 2021 is Column B and C summed, which is 567+1008=1575. It should be noted that a number with a decimal is presented in Column D due to presence of computer generated numbers used to populate the spreadsheet 200 in simulations.

Total daily demand under Column D is used in obtaining the standard deviation of total demand σ_{D} on Mar. 1, 2021 (as the present day). Specifically, the standard deviation of total demand σ_{D} under Column E is taken over the present total demand in Column D on Mar. 1, 2021 (total demand 1574.2), as well as over the total demand in Column D of the past days Feb. 15, 2021 (total demand 1158.3) and Feb. 1, 2021 (total demand 1138.1).

Obtaining the standard deviation of total demand is a fairly straightforward mathematical operation that is now briefly described. First the mean of the daily demand over the three noted days is performed: (1138.1+1158.3+1574.2)/3=1290.2.

Secondly, the variance from the mean of the demand of each past day and present day is squared (to remove negative numbers). The total of the squared variances is then divided by the total number of days to obtain a mean variance among the days under consideration:

| | | |
|---|---|---|
| Feb. 1, 2021 | (1138.1 − 1290.2)²= | 23134.41+ |
| Feb. 15, 2021 | (1158.3 − 1290.2)²= | 17397.61+ |
| Mar. 1, 2021 | (1574.2 − 1290.2)²= | 80656.00+ |
| | | 121,188.02/3 = 40396.001 = mean |
| | | variance squared |

The square root of the mean variance squared is taken to obtain the standard deviation of total demand:

\sqrt{40396.001}=200.988=201=σ_{D}.

The standard deviation of total demand σ_{D} is therefore set to 201.

Next, Column F at Row 3 describes that the lead time for the demand of 567 units on Mar. 1, 2021 by Customer 1 is 31 days. Column G at Row 3 describes that the lead time for the demand of 1008 units on Mar. 1, 2021 by Customer 2 is 3 days. The average present lead time on Mar. 1, 2021 is therefore (576+1008)/2=17 days, as seen at Column H, Row 3. The average present lead time of the present demand L̅T̅ in Equation 1 is set to 17 days.

The standard deviation of average lead time σ_{LT} is taken over the present average lead time Column H on Mar. 1, 2021 (Row 3, average lead time 17), as well as over the past average lead time in Column H of the past days Feb. 15, 2021 (Row 2, average lead time 14.5) and Feb. 1, 2021 (Row 1, average lead time 13).

Column I at Row 3 (Mar. 1, 2021) shows the result of the standard deviation of average lead time calculation over the present average lead time of the present day and the past average lead time of the two past days. The standard deviation of average lead time σ_{LT} calculation proceeds in manner similar to the calculation of the standard deviation of total demand σ_{D} discussed in detail above, and is not presented herein.

As seen at Column I at Row 3, the standard deviation of average lead time σ_{LT} on Mar. 1, 2021 is 1.6. Thus, the standard deviation of average lead time σ_{LT} is set to 1.6

In summary, the exemplary spreadsheet 200 illustrates that for a given present day on Mar. 1, 2021, the variables in Equation 1 are set as follows:
L̅T̅=17;
σ_{D}=201, and σ_{d}²=40401;
D̅=788; and
σ_{LT}=1.6, and σ_{LT}=2.56.

It should be noted again that:

$${σ}_{LTD} = \sqrt{\overline{LT} * {σ}_{D}^{2} + \overline{D} * {σ}_{LT}^{2}} \qquad ( Equation 1 )$$

The calculation of the standard deviation of lead time demand a LTD on Mar. 1, 2021 is:
\sqrt{(17*40401)+(788*2.56)};
\sqrt{686817+2017.28};
\sqrt{688834.28}=829.960

To restate succinctly, the standard deviation of lead time demand σ_{LTD}=830. However, Equation 2 specifies that safety stock correction SS=Z*σ_{LTD}. Therefore, the safety stack correction SS=0.95*830=788.5=789. This calculation of safety stock correction is reflected at Column J at Row 3, and represents a number of units of the item over standard inventory for meeting intense increases in demand.

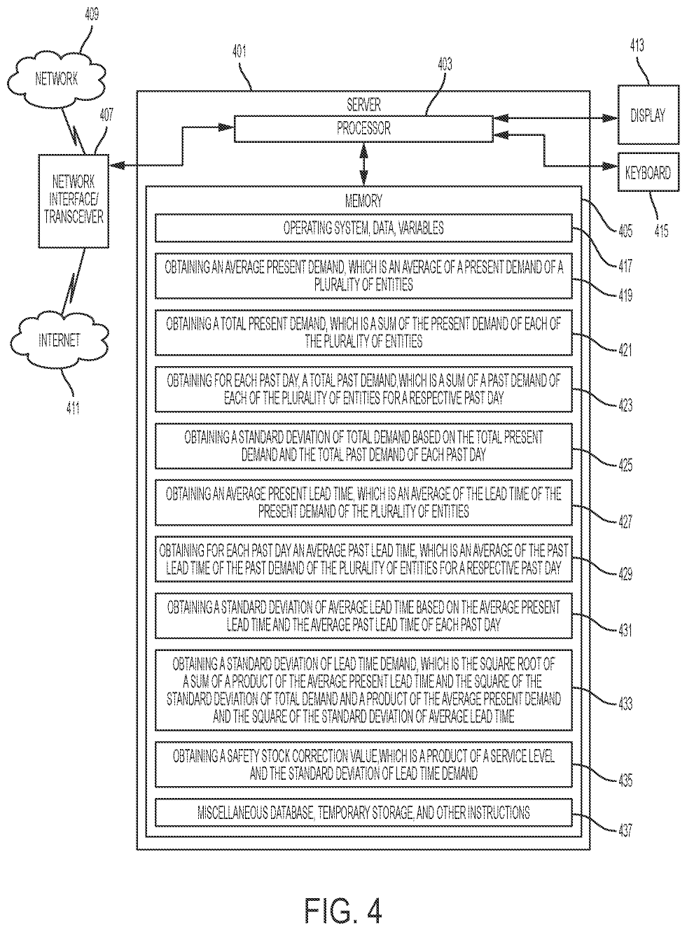

Turning now to FIG. 4, a block diagram illustrating a safety stock apparatus (server) 401 for obtaining a safety stock correction is described. The safety stock correction server 401 is configured to implement a safety stock correction functionality.

The safety stock correction server 401 may include a transceiver 407, a processor 403, a memory 405, a display mechanism 413, and a keypad and/or touch screen 415. The transceiver 407 may be equipped with a network interface that allows the safety stock correction server 401 to communicate with other devices in an enterprise or other network 409

The computer programs cause the processor 403 to operate in connection with or over the Internet 411. Alternatively, the network interface may be provided in a separate component coupled with the transceiver 407.

The processor 403 may comprise one or more microprocessors and/or one or more digital signal processors. The memory 405 may be coupled to the processor 403 and may comprise a read-only memory (ROM), a random-access memory (RAM), a programmable ROM (PROM), and/or an electrically erasable read-only memory (EEPROM). The memory 405 may include multiple memory locations for storing, among other things, an operating system, data and variables 417 for computer programs executed by the processor 403.

The computer programs in memory 405 cause the processor 403 to operate in connection with various functions as now described. An obtain average present demand function 419 causes the processor 403 to obtain an average present demand, which is an average of a present demand of a plurality of entities. An obtain total present demand function 421 causes the processor 403 to obtain a total present demand, which is a sum of the present demand of each of the plurality of entities.

An obtain total past demand function 423 causes the processor 403 to obtain for each past day, a total past demand, which is a sum of a past demand of each of the plurality of entities for a respective past day. An obtain standard deviation of total demand function 425 causes the process 403 to obtain a standard deviation of total demand based on the total present demand and the total past demand of each past day.

An obtain average present lead time function 427 causes the processor 403 to obtain an average present lead time, which is an average of the lead time of the present demand of the plurality of entities. An obtain average past lead time function 429 causes the processor 403 to obtain for each past day an average past lead time, which is an average of the past lead time of the past demand of the plurality of entities for a respective past day. An obtain standard deviation of average lead time function 431 causes the processor 403 to obtain a standard deviation of average lead time based on the average present lead time and the average past lead time of each past day.

An obtain standard deviation of lead time demand function 433 causes the processor 403 to obtain a standard deviation of lead time demand, which is the square root of a sum of a product of the average present lead time and the square of the standard deviation of total demand and a product of the average present demand and the square of the standard deviation of average lead time. An obtain safety stock correction function 435 causes the processor 403 to obtain a safety stock correction value, which is a product of a service level and the standard deviation of lead time demand.

The above described functions stored as computer programs may be stored, for example, in ROM or PROM and may direct the processor 403 in controlling the operation of the safety stock correction server 401. The memory 405 can additionally store a miscellaneous database and temporary storage 437 for storing other data and instructions not specifically mentioned herein.

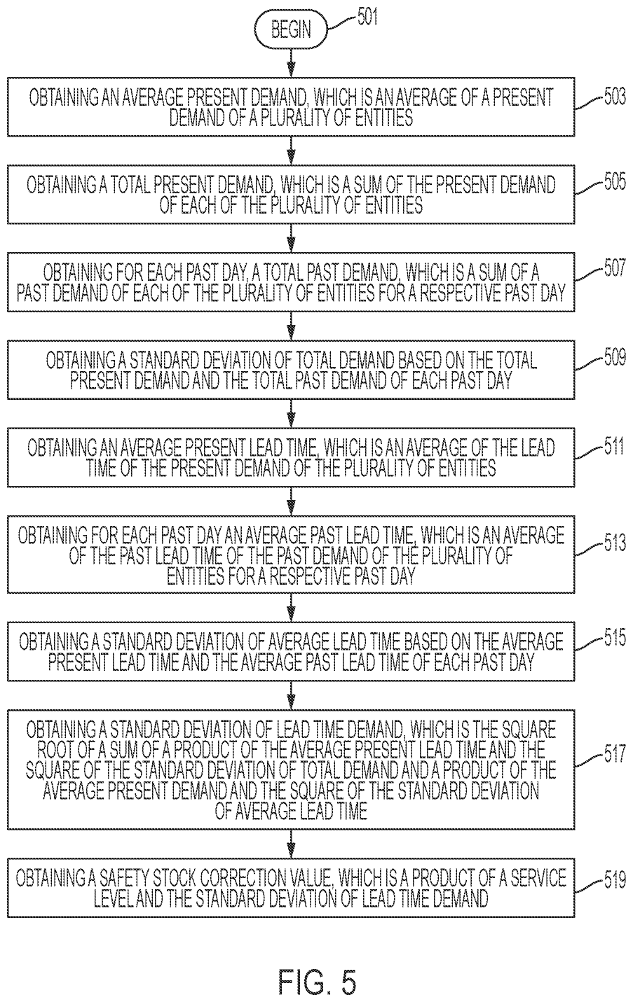

Turning now to FIG. 5, a flow chart illustrating a safety stock correction method us described. The safety stock correction method is advantageously implemented in a safety stock correction apparatus including a communication interface, a memory, and a processor. When one or more entities initiate a demand for items supplied and/or produced by an enterprise, the safety stock correction method, performed by the processor, begins at 501.

The safety stock method comprises obtaining 503 an average present demand, which is an average of a present demand of a plurality of entities. The safety stock method further comprises obtaining 505 a total present demand, which is a sum of the present demand of each of the plurality of entities. The safety stock method further comprises obtaining 507 for each past day, a total past demand, which is a sum of a past demand of each of the plurality of entities for a respective past day. The safety stock method further comprises obtaining 509 a standard deviation of total demand based on the total present demand and the total past demand of each past day.

The safety stock method further comprises obtaining 511 an average present lead time, which is an average of the lead time of the present demand of the plurality of entities. The safety stock method further comprises obtaining 513 for each past day an average past lead time, which is an average of the past lead time of the past demand of the plurality of entities for a respective past day. The safety stock method further comprises obtaining 515 a standard deviation of average lead time based on the average present lead time and the average past lead time of each past day.

The safety stock method further comprises obtaining 517 a standard deviation of lead time demand, which is the square root of a sum a product of the average present lead time and the square of the standard deviation of total demand and a product of the average present demand and the square of the standard deviation of average lead time. The safety stock method further comprises obtaining 519 a safety stock correction value, which is a product of a service level and the standard deviation of lead time demand.

This disclosure is intended to explain how to fashion and use various embodiments in accordance with inventive principles, rather than to limit the true, intended, and fair scope and spirit thereof. The foregoing description is not intended to be exhaustive or to limit the inventive principles to the precise form disclosed. Modifications or variations are possible in light of the above teachings. The embodiments disclosed and discussed herein were chosen and described to provide the best illustration of the inventive principles and the practical application thereof, and to enable one of ordinary skill in the art to utilize the inventive principles in various embodiments and with various modifications as are suited to the particular use contemplated. All such modifications and variations should be deemed to be within the scope of the inventive principles disclosed herein.

What is claimed is:

1. A safety stock correction server comprising:
an electronic data storage;
a transceiver configured to transmit and receive data over a network;
a processor; and
a bus configured to transfer data among the electronic data storage, the transceiver, and the processor, rendering the processor cooperatively operable with the electronic data storage and the transceiver, wherein:
the electronic data storage stores:
a begin day,
a present day, the present day being subsequent to the begin day,
at least one past day, which is any day between the begin day and the present day,
for each of a plurality of different entities, a present demand, which is a number of units of an item requested on the present day by an entity,
for each of the plurality of different entities, a present lead time, which is a number of days between the present day and a present delivery day, which is a day for delivery to an entity of its present demand,
for each of the plurality of entities, and for each past day, a past demand, which is a number of units of the item requested by an entity on a respective past day,
for each of the plurality of entities, and for each past day, a past lead time, which is a number of days between a past day and a past delivery day, which is a day for delivery to an entity of a past demand, and
a service level, which is a percentage value representing how often units of the item are expected to be delivered within a given lead time;
the processor performs a safety stock correction calculation for the present day, whereby the processor:
obtains an average present demand, which is an average of the present demand of the plurality of entities,
obtains a total present demand, which is a sum of the present demand of each of the plurality of entities,
obtains for each past day, a total past demand, which is a sum of the past demand of each of the plurality of entities for a respective past day,
obtains a standard deviation of total demand based on the total present demand and the total past demand of each past day,
obtains an average present lead time, which is an average of the lead time of the present demand of the plurality of entities,
obtains for each past day an average past lead time, which is an average of the past lead time of the past demand of the plurality of entities for a respective past day,
obtains a standard deviation of average lead time based on the average present lead time and the average past lead time of each past day,
obtains a standard deviation of lead time demand, which is the square root of a sum of a first addend and a second addend,
the first addend being a product of the average present lead time and the square of the standard deviation of total demand, and
the second addend being a product of the average present demand and the square of the standard deviation of average lead time, and
obtains a safety stock correction value, which is a product of the service level and standard deviation of lead time demand, and which represents a number of units of the item over standard inventory for meeting intense increases in demand.

2. The safety stock correction server of claim 1, wherein:
the present demand of each of the plurality of entities and the present lead time of each present demand are received in the electronic data storage via manual entry at the safety stock correction server via a peripheral.

3. The safety stock correction server of claim 2, wherein:
the past demand of each past day of each of the plurality of entities and the past lead time of each past demand were received in the electronic data storage via manual entry at the safety stock correction server at a time when each past day was a present day.

4. The safety stock correction server of claim 1, wherein:
the present demand of each of the plurality of entities and the present lead time of each present demand are received in the electronic data storage via the transceiver from a network client device on the network and via an automated process.

5. The safety stock correction server of claim 4, wherein:
the past demand of each past day of each of the plurality of entities and the past lead time of each past demand were received in the electronic data storage via the transceiver from the network client device on the network and via the automated process at a time when each past day was a present day.

6. The safety stock correction server of claim 1, wherein:
the safety stock correction is transferred, via the transceiver, over the network to one of a client device on the network and a remote device connected through the internet or a device; and
the one of the client device and the remote device automatedly processes transfers of current inventory to fill outstanding demand for the item.

7. A safety stock correction method, implemented in an apparatus configured as a node on a network, the apparatus including an electronic data storage, a transceiver configured to transmit and receive data over the network, a processor, and a bus configured to transfer data among the electronic data storage, the transceiver, and the processor, the method comprising:
storing by the electronic data storage:
a begin day,
a present day, the present day being subsequent to the begin day,
at least one past day, which is any day between the begin day and the present day,
for each of a plurality of different entities, a present demand, which is a number of units of an item requested on the present day by an entity,
for each of the plurality of different entities, a present lead time, which is a number of days between the present day and a present delivery day, which is a day for delivery to an entity of its present demand,
for each of the plurality of entities, and for each past day, a past demand, which is a number of units of the item requested by an entity on a respective past day,
for each of the plurality of entities, and for each past day, a past lead time, which is a number of days between a past day and a past delivery day, which is a day for delivery to an entity of a past demand, and
a service level, which is a percentage value representing how often units of the item are expected to be delivered within a given lead time;
performing, by the processor, a safety stock correction for the present day, including
obtaining an average present demand, which is an average of the present demand of the plurality of entities,
obtaining a total present demand, which is a sum of the present demand of each of the plurality of entities,
obtaining for each past day a total past demand, which is a sum of the past demand of each of the plurality of entities for a respective past day,
obtaining a standard deviation of total demand based on the total present demand and the total past demand of each past day,
obtaining an average present lead time, which is an average of the lead time of the present demand of the plurality of entities,
obtaining for each past day an average past lead time, which is an average of the past lead time of the past demand of the plurality of entities for a respective past day,
obtaining a standard deviation of average lead time based on the average present lead time and the average past lead time of each past day,
obtaining a standard deviation of lead time demand, which is the square root of a sum of a first addend and a second addend,
the first addend being a product of the average present lead time and the square of the standard deviation of total demand, and
the second addend being a product of the average present demand and the square of the standard deviation of average lead time, and
obtaining a safety stock correction value, which is a product of the service level and standard deviation of lead time demand, and which represents a number of units of the item over standard inventory for meeting intense increases in demand.

8. The safety stock correction method of claim 7, further comprising:
receiving, by the electronic data storage via manual entry at the apparatus via a peripheral, the present demand of each of the plurality of entities and the present lead time of each present demand.

9. The safety stock correction method of claim 8, further comprising:
receiving, by the electronic data storage via manual entry at the apparatus via the peripheral, at a time when each past day was a present day, the past demand of each past day of each of the plurality of entities and the past lead time of each past demand.

10. The safety stock correction method of claim 7, further comprising:
receiving, by the electronic data storage via the transceiver from a network client device on the network and via an automated process, the present demand of each of the plurality of entities and the present lead time of each present demand.

11. The safety stock correction method of claim 10, further comprising:
receiving by the electronic data storage via the transceiver from the network client device on the network and via the automated process at a time when each past day was a present day, the past demand of each past day of each of the plurality of entities and the past lead time of each past demand.

12. The safety stock correction method of claim 7, further comprising
transferring, by the transceiver over the network to one of a client device on the network and a remote device connected through the internet, the safety stock correction, wherein
the one of the client device and the remote device automatedly processes transfers of current inventory to fill outstanding demand for the item.

13. A non-transitory computer-readable storage medium having instructions stored thereon, that when executed by an apparatus, configured as a node on a network, the apparatus including an electronic data storage, a transceiver configured to transmit and receive data over the network, a processor, and a bus configured to transfer data among the electronic data storage, the transceiver, and the processor, cause the apparatus to perform a method comprising:
storing by the electronic data storage:
a begin day,
a present day, the present day being subsequent to the begin day,
at least one past day, which is any day between the begin day and the present day,
for each of a plurality of different entities, a present demand, which is a number of units of an item requested on the present day by an entity,
for each of the plurality of different entities, a present lead time, which is a number of days between the present day and a present delivery day, which is a day for delivery to an entity of its present demand,
for each of the plurality of entities, and for each past day, a past demand, which is a number of units of the item requested by an entity on a respective past day,
for each of the plurality of entities, and for each past day, a past lead time, which is a number of days between a past day and a past delivery day, which is a day for delivery to an entity of a past demand, and
a service level, which is a percentage value representing how often units of the item are expected to be delivered within a given lead time;
performing, by the processor, a safety stock correction for the present day, including
obtaining an average present demand, which is an average of the present demand of the plurality of entities,
obtaining a total present demand, which is a sum of the present demand of each of the plurality of entities,
obtaining for each past day, a total past demand, which is a sum of the past demand of each of the plurality of entities for a respective past demand,
obtaining a standard deviation of total demand based on the total present demand and the total past demand of each past day,
obtaining an average present lead time, which is an average of the lead time of the present demand of the plurality of entities,
obtaining for each past day, an average past lead time, which is an average of the past lead time of the past demand of the plurality of entities for a respective past day,
obtaining a standard deviation of average lead time based on the average present lead time and the average past lead time of each past day,
obtaining a standard deviation of lead time demand, which is the square root of a sum of a first addend and a second addend,
the first addend being a product of the average present lead time and the square of the standard deviation of total demand, and
the second addend being a product of the average present demand and the square of the standard deviation of average lead time, and
obtaining a safety stock correction value, which is a product of the service level and standard deviation of lead time demand, and which represents a number of units of the item over standard inventory for meeting intense increases in demand.

14. The non-transitory computer-readable storage medium according to claim 13, having further instructions stored thereon, that when executed by the apparatus, cause the method performed by the apparatus to further comprise:
receiving, by the electronic data storage via manual entry at the apparatus via a peripheral, the present demand of each of the plurality of entities and the present lead time of each present demand.

15. The non-transitory computer-readable storage medium according to claim 14, having further instructions stored thereon, that when executed by the apparatus, cause the method performed by the apparatus to further comprise:
receiving, by the electronic data storage via manual entry at the apparatus via a peripheral, at a time when each past day was a present day, the past demand of each past day of each of the plurality of entities and the past lead time of each past demand were.

16. The non-transitory computer-readable storage medium according to claim 13, having further instructions stored thereon, that when executed by the apparatus, cause the method performed by the apparatus to further comprise:
receiving, by the electronic data storage via the transceiver from a network client device on the network and via an automated process, the present demand of each of the plurality of entities and the present lead time of each present demand.

17. The non-transitory computer-readable storage medium according to claim 16, having further instructions stored thereon, that when executed by the apparatus, cause the method performed by the apparatus to further comprise:
receiving by the electronic data storage via the transceiver from the network client device on the network and via the automated process, at a time when each past day was a present day, the past demand of each past day of each of the plurality of entities and the past lead time of each past demand.

18. The non-transitory computer-readable storage medium according to claim 13, having further instructions stored thereon, that when executed by the apparatus, cause the method performed by the apparatus to further comprise:
transferring, by the transceiver over the network to one of a client device on the network and a remote device connected through the internet, the safety stock correction, wherein
the one of the client device and the remote device automatedly processes transfers of current inventory to fill outstanding demand for the item.
